(19) United States
(12) Patent Application Publication
(10) Pub. No.: US 2015/0147611 A1
(43) Pub. Date: May 28, 2015

(54) FLOW BATTERY POWER MODULE BACKPLANE

(71) Applicant: WattJoule Corporation, Devens, MA (US)

(72) Inventor: Gregory R. Cipriano, Hopkinton, MA (US)

(21) Appl. No.: 14/552,780

(22) Filed: Nov. 25, 2014

Related U.S. Application Data
(60) Provisional application No. 61/909,425, filed on Nov. 27, 2013.

(51) Int. Cl. H01M 8/18

(52) U.S. Cl. CPC H01M 8/188
USPC 429/70

(57) ABSTRACT

In an embodiment, a flow battery system with power producing components, having one or multiple stacks, pumps and related components wherein such components are mechanically mounted into, and fully supported by, a common backplane. Electrical and hydraulic interconnections are provided by the backplane and the backplane consists of one electromechanical assembly that will substantially reduce costs, and improve energy efficiency and serviceability. Multiple stacks and pumps may be interconnected in a single backplane in various serial and parallel configurations. In turn, multiple backplanes may be interconnected in various serial and parallel configurations, to build larger systems, depending on the application.

### RELATED APPLICATIONS

This application claims priority to and the benefit of U.S. Provisional Patent Application No. 61/909,425, filed on Nov. 27, 2013 and titled “Flow Battery Power Module Backplane”, the contents of which are incorporated by reference as though fully set forth herein.

### BACKGROUND

A flow battery system generally consists of a liquid electrolyte pumped through an array of one or more stacks that allow one to both charge the liquid with electrical energy and discharge electrical energy from the liquid. Each stack is comprised of an array of electrochemical cells. The liquid is commonly referred to as the energy component of the system. The part of the system incorporating the stacks, pumps and associated balance of system we refer to as the power component and alternatively the power module.

There are two different electrolytes required for the operation of the flow battery stack. One is called the catholyte and the other is called the anolyte and they travel along separate fluid paths in the stack and are stored in their respective external tanks. Typical power modules contain any number of stacks that 1) are both electrically and hydraulically interconnected in various series and parallel configurations depending on the requirements of the energy storage system and multiple engineering considerations and 2) require a separate support structure for the stacks and pumps.

### BRIEF DESCRIPTION OF THE DRAWINGS

The accompanying drawings, which are incorporated in and constitute a part of this specification, illustrate one or more embodiments described herein and, together with the description, explain these embodiments. The components of the drawings are not necessarily drawn to scale, the emphasis instead being placed upon illustrating principles of the present disclosure. In the drawings:

FIG. 1 illustrates an example assembly that includes an array of stacks with associated catholyte and anolyte electrolyte pumps and a backplane;

FIG. 2 illustrates an example interface that may be associated with a stack that may be included in the assembly; and

FIG. 3 illustrates an example of how a stack may connect to the backplane.

### DETAILED DESCRIPTION

Typical problems that may exist with some flow battery systems include: 1) they may require a complex network of hand-assembled piping and wiring, combined with a mechanical support framework that is material and labor intensive, and therefore costly, to manufacture, 2) they may require more volumetric space per kilowatt-hour (kWh) of energy storage since all interconnections must allow the entry of human hands in and around the stack arrays for manufacturing and maintenance, and 3) replacement of a failed stack or pump is labor intensive, time consuming and can result in fluid loss or spillage.

Embodiments of a new system integration approach for flow battery power modules is described. The approach includes, for example, a modular unitized flow battery stack design that allows, inter alia, individual stacks to be easily inserted into and removed from a backplane. The backplane provides, for example, integrated functions in one electromechanical assembly.

The provided functions may include, for example, (1) mechanical support and retention for the stacks and pumps, (2) hydraulic interconnections for liquid catholyte and anolyte flowing through the stacks, in a variety of serial and parallel configurations, (3) electrical interconnections for the stacks, in a variety of serial and parallel configurations, (4) provisions for obviating shunt current losses that may occur between stacks and (5) integration of the above functions 1 through 4 based on a fast connect “plug-n-play” backplane. The entire assembly may be oriented either vertically or horizontally or any inclination between these two orientations.

In an embodiment, an assembly includes a backplane and a stack. The backplane may provide an electrical connection and a hydraulic connection. The electrical connection and hydraulic connection is provided by the backplane to the stack. The stack has an interface that is operable to insert the stack into the backplane and remove the stack from the backplane. The interface includes an electrical connection that interconnects with the electrical connection of the backplane after the stack is inserted into the backplane, and a hydraulic connection that interconnects with the hydraulic connection of the backplane after the stack is inserted into the backplane. The assembly operates as a flow battery after the stack is inserted into the backplane.

In an embodiment, the assembly includes a pump that provides circulation of electrolyte flow material utilized by the stack. The pump includes a motor portion that is detachable from the pump. The motor portion is insertable into and removable from the backplane. The pump includes an impeller portion that may be embedded into a hydraulic manifold contained in the backplane. The pump is a magnetic drive pump although other types of pumps (e.g., direct drive pumps) may be used.

In an embodiment, a flow battery system includes, for example, a backplane, a plurality of stacks, and a plurality of pumps. The stacks and pumps are mechanically mounted into the backplane. The backplane provides electrical and hydraulic interconnections to the stacks and pumps.

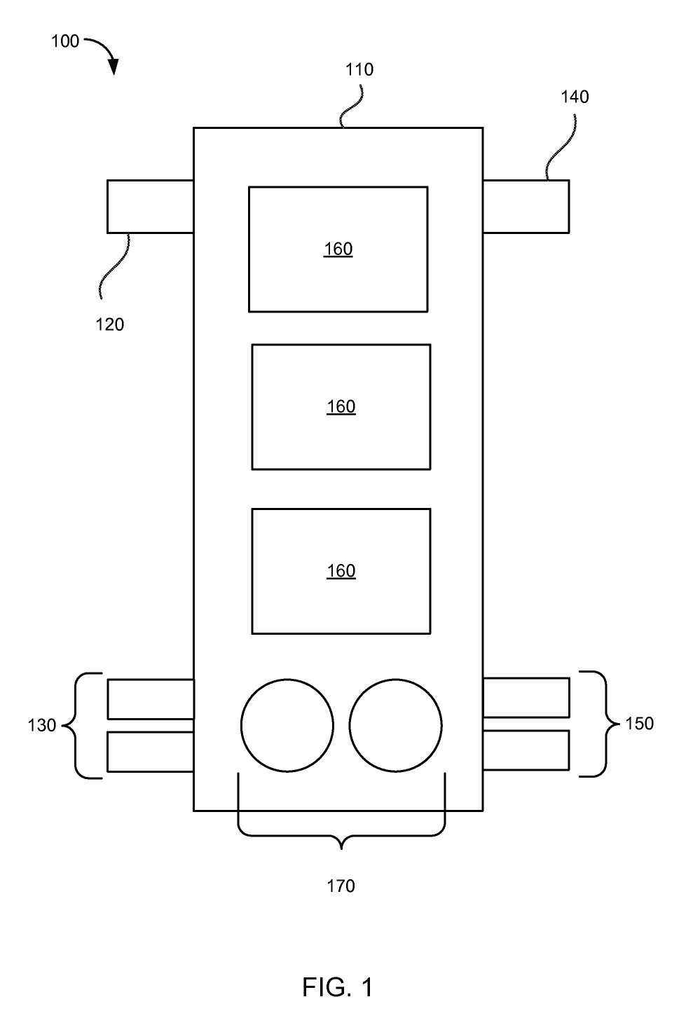

FIG. 1 illustrates an assembly 100 that includes stacks 160, with associated catholyte and anolyte electrolyte pumps 170, mounted on, and plugged into a backplane 110. The assembly 100 may be included in a flow battery system. The assembly 100 may be either horizontal or vertical in orientation.

Referring to FIG. 1, assembly 100 may include various components such as, for example, stacks 160, pumps 170, a backplane 110, a positive electrical busbar connector 120, a negative busbar connector 140, catholyte hydraulic connectors 130, and anolyte hydraulic connectors 150.

As illustrated in FIG. 1, assembly 100 includes three stacks 160 and two pumps 170 for backplane 110. It should be noted, however, for any one backplane 110, there can be any number of stacks 160 and pumps 170. These stacks 160 and pumps 170 may also be arrayed in multiple rows on a backplane 110.

Single and multiple backplanes 110 may be connected directly to catholyte and anolyte tanks, and to power conversion equipment. Multiple backplanes 110 may be interconnected both electrically and hydraulically, in various serial and parallel configurations to meet the overall requirements of the flow battery system.

Within any one backplane 110, stacks 160 and electrolyte pumps 170 may be interconnected both electrically and hydraulically in various parallel and/or serial array configurations. Hydraulic flow paths and electrical conduction paths may be embedded and supported within the backplane 110 and mechanically protected by its structure. This mechanical protection will provide additional safety for service personnel. Stacks 160 and pumps 170 are typically fully supported by the backplane 110 and may require no other support mechanical structure.

Within any one backplane 110, there may be provided specially configured hydraulic paths, the purpose of which may be to obviate shunt current losses that may occur between the stacks 160 in the backplane 110, thereby increasing, for example, a net energy efficiency of the flow battery system.

Provisions to add and replace stacks 160, pumps 170, and/or other components may necessitate that any one backplane 110 be removed from the overall system operation, isolated both electrically and hydraulically, thereby facilitating fast and safe servicing by trained personnel.

A stack 160 may include an interface that may interface the stack 160 with the backplane 110. The interface may be “keyed” to allow the stack 160 to be inserted into the backplane 110 in only one way. The interface may contain a set of connectors that allow easy “plug-n-play” operation, so that the stack 160 can be easily inserted into and removed from the backplane 110. Individual connectors in the stack 160 may be designed to mate with corresponding connectors in the backplane 110.

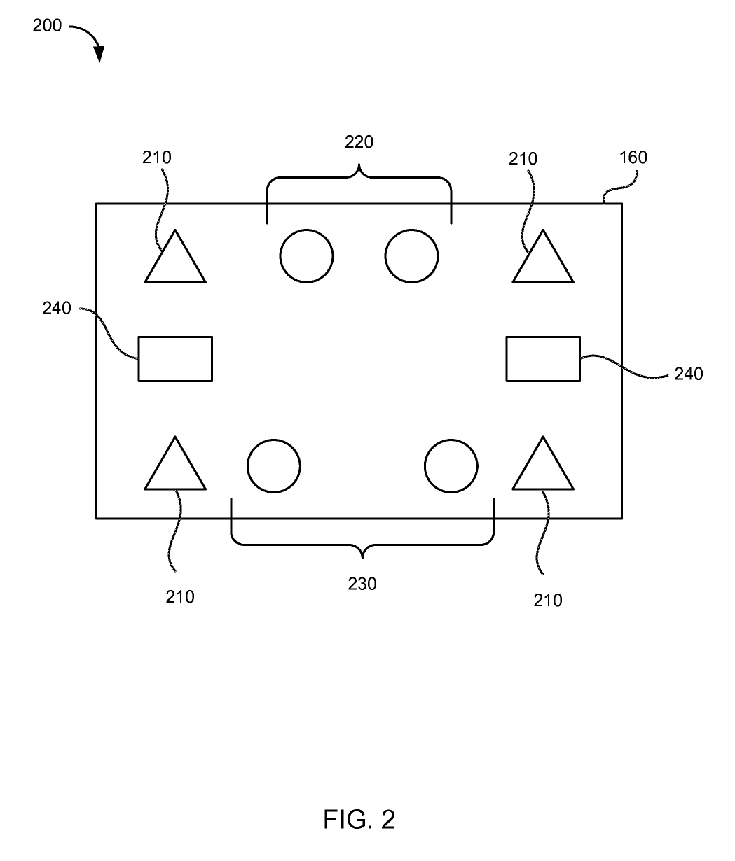

FIG. 2 illustrates an example interface 200 that may be used with a stack 160. The interface 200 may interface the stack 160 with the backplane 110. The interface 200 may be located on a back side of the stack 160. The interface 200 may be operable to insert the stack 160 into the backplane 110 and remove the stack from the backplane 110. Assembly 100 may operate as a flow battery after the stack 160 is inserted into the backplane 110 via the interface 200.

Referring to FIG. 2, the interface 200 may include, for example, four types of connectors. These connectors may include, for example, (1) a pair of anolyte hydraulic connectors 220, (2) a pair of catholyte hydraulic connectors 230, (3) a pair of electrical connectors 240, and (4) four alignment/fastener connectors 210. Stacks 160 may typically have male type connectors and the backplane 110 will typically have female type connectors. The connectors may be reversed or intermixed as required.

The connectors may provide mechanical alignment when inserting the stack 160 into the backplane 110. Here, for example, a user inserting the stack may not be able to see the connectors but alignment may be assured by a design of the connector. This type of connector may be referred to as a blind-mating connector.

Hydraulic connectors 220, 230 may be, for example, blind-mating, self-aligning, low insertion force, self-sealing connectors. Hydraulic connectors 220, 230 may, for example, employ multiple sets of seals per connector for reliability and leak-proof operation.

Removing stack 160 from backplane 110 may cause connectors 220, 230 to become disengaged. After being disengaged, connectors 220, 230 may automatically close. Moreover, after connectors 220, 230 are disengaged, corresponding connectors on the backplane 110 may automatically close. Automatic closing of connectors 220, 230 and the corresponding connectors on the backplane 110 may prevent fluid leakage and provide no-drip operation. An example of a connector that may be used to implement connectors 220, 230 is the commercially available Koolance® Quick Connect Series hydraulic connector, available from Koolance Incorporated, Auburn, Wash.

The electrical connectors 240 may typically be blind-mating, self-aligning, low insertion force, multi-contact connectors. An example of a connector that may be used to implement connectors 240 is the commercially available TE Elcon Drawer Series electrical connector, available from TE Connectivity Ltd., Rheinstrasse 20 Ch-8200 Schaffhausen, Switzerland.

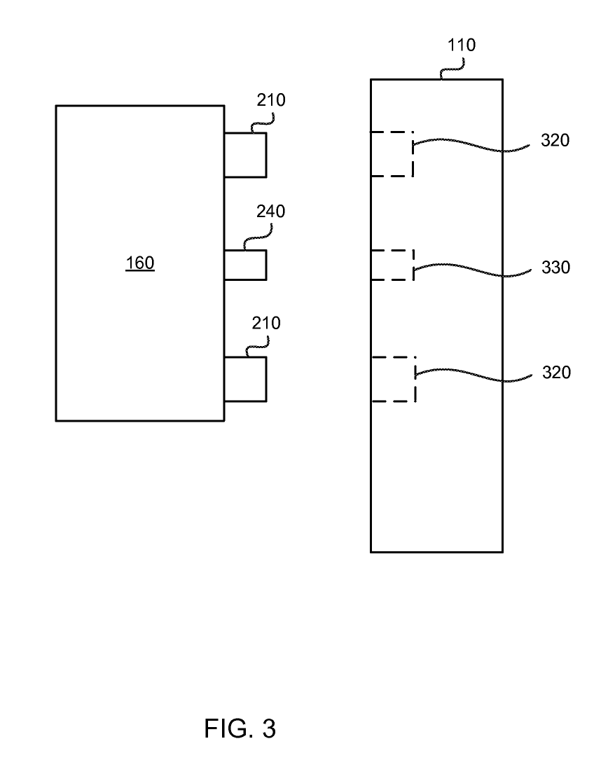

FIG. 3 illustrates an example of how a stack 160 may connect to the backplane 110. Referring now to FIGS. 2 and 3, in an embodiment, alignment/fastener connectors 210 may contact the backplane 110 first, thereby facilitating the alignment process. This may allow the stack 160 to be well aligned to the backplane 110 before other connectors, such as, for example, connectors 220, 230, and/or 240 physically touch corresponding connections on backplane 110.

The alignment/fastener connectors 210 may be self-centering (such as, for example, cone shaped rods) in order to guide the connections on the backplane 110 and stack 160 into proper position. This may reduce mechanical stress on connectors 320, 330 contained on the backplane 110 and/or connectors 210, 220, 230, 240 contained on the stack 160 during insertion of the stack 160 into the backplane 110 and/or removal of the stack 160 from the backplane 110. The alignment/fastener connectors 210 may mate (interconnect) with corresponding connectors 320 that may be contained on backplane 110.

The alignment/fastener connectors 210 may have a fastening mechanism that may be engaged to mechanically lock the stack 160 into the backplane 110 after the stack 160 is fully inserted into the backplane 110. The fastening mechanism may be as simple as a through-bolt or a more complex locking cam mechanism. The fastening mechanism may also be external to the stack 160 using, for example, mating clamps that may grasp an outer shell of the stack 160 and mechanically secure it to the backplane 110.

The backplane 110 may include one or more connections that may interconnect with, for example, one or more hydraulic connections and/or the one or more electrical connections contained on the stacks 160 and/or pumps 170 (FIG. 1). For example, backplane 110 may contain hydraulic connections that may interconnect with connections 220 and/or 230 after stack 160 is inserted into backplane 110. Moreover, backplane 110 may contain one or more electrical connectors 330 that may interconnect with connectors 240 after stack 160 is inserted into backplane 110.

Referring back to FIG. 1, pumps 170 may also mate to the backplane 110 in a keyed fashion. Moreover, pumps 170 may be fastened to the backplane 110 and/or mechanically supported by the backplane 110. In an embodiment, pumps 170 are connected to backplane 110 using a number of machine bolts.

A pump 170 may be, for example, a magnetic drive pump although other types of pumps may be used. The pump may include a motor portion and/or a fluid impeller portion. The fluid impeller portion of the pump 170 may be embedded into and/or be an integral part of a hydraulic manifold that may be contained in the backplane 110. This may allow a fluid path to remain completely sealed to the environment, which may be a major advantage if motor portion of the pump 170 needs to be replaced in the field. This replacement may be performed, for example, in order to either provide a more powerful pump 170 in order to increase the flow rate and/or pressure beyond the capacity of the existing pump 170, or to replace a failed pump 170.

Provisions may also be made in the backplane 110, for example, for multiple pumps 170 for each electrolyte side separately, i.e. the catholyte and anolyte. Here, for example, the backplane 110 may have multiple embedded impellers with mating surfaces for multiple pump 170 but only have some pumps 170 installed depending on the needs of the energy storage application.

It should be noted that backplane 110 may support a full integration of other components. For example, backplane 110 may support a full integration of a number of sensors, valves, auxiliary wiring and plumbing, and other necessary flow battery system components.

The foregoing description of embodiments is intended to provide illustration and description, but is not intended to be exhaustive or to limit the invention to the precise form disclosed. Modifications and variations are possible in light of the above teachings or may be acquired from practice of the invention.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It is intended that the invention not be limited to the particular embodiments disclosed above, but that the invention will include any and all particular embodiments and equivalents falling within the scope of the following appended claims.

What is claimed is:

1. An assembly comprising:
a backplane providing an electrical connection and a hydraulic connection; and
a stack having an interface that is operable to insert the stack into the backplane and remove the stack from the backplane, the interface including:
an electrical connection that interconnects with the electrical connection of the backplane after the stack is inserted into the backplane, and
a hydraulic connection that interconnects with the hydraulic connection of the backplane after the stack is inserted into the backplane.

2. The assembly of claim 1, wherein the assembly operates as a flow battery after the stack is inserted into the backplane.

3. The assembly of claim 1, further comprising:
a pump that provides circulation of electrolyte flow material utilized by the stack.

4. The assembly of claim 3, wherein the pump is a magnetic drive pump.

5. The assembly of claim 3, wherein the pump includes an impeller portion that is embedded into a hydraulic manifold contained in the backplane.

6. The assembly of claim 3, wherein the pump includes a motor portion that is detachable from the pump.

7. The assembly of claim 6, wherein the motor portion is inserted into and removed from the backplane.

8. A flow battery system comprising:
a backplane;
a plurality of stacks; and
a plurality of pumps,
wherein the stacks and pumps are mechanically mounted into the backplane, and
wherein the backplane provides electrical and hydraulic interconnections to the stacks and pumps.

9. The flow battery system of claim 8, wherein the backplane is contained in a single electromechanical assembly.

10. The flow battery system of claim 8, wherein the backplane includes provisions for facilitating an insertion and removal of the stacks and pumps.

11. The flow battery system of claim 8, wherein the backplane is oriented horizontally or vertically, or any inclination between the two.
